(19) United States
(12) Patent Application Publication
(10) Pub. No.: US 2011/0048764 A1
(43) Pub. Date: Mar. 3, 2011

(54) HIGH FREQUENCY EXTRAFINE PAIR CABLE AND METHOD FOR MANUFACTURING THE SAME

(75) Inventors: Kazuo Hira, Kagawa (JP); Shigeru Kobayashi, Kagawa (JP)

(73) Assignee: YOSHINOGAWA ELECTRIC WIRE & CABLE CO., LTD., Kagawa (JP)

(21) Appl. No.: 12/553,618

(22) Filed: Sep. 3, 2009

(30) Foreign Application Priority Data
Sep. 1, 2009 (JP) 2009-202070

(51) Int. Cl. H01B 11/06; H01B 11/02; H01R 43/00

(52) U.S. Cl. 174/105 R; 174/113 R; 174/116; 29/825

(57) ABSTRACT

The present invention is directed to a high frequency extrafine pair cable, wherein a pair cable is accommodated in a shield tube assuming the form of a hollow cylinder, the pair cable comprising two insulation coated wires each comprising an inner conductor and an insulator layer formed on an outer circumference of the inner conductor, and a space is present between the pair cable and an inner surface of the shield tube in a region other than the region where a part of the pair cable is in contact with the inner surface of the shield tube. The high frequency extrafine pair cable has excellent electrical characteristics, such as low transmission loss, and enables implementation of an extrafine cable structure. The invention is also directed to a method for manufacturing the same.

### TECHNICAL FIELD

The present invention relates to a high frequency extrafine pair cable and a method for manufacturing the same, and more particularly to a high frequency extrafine pair cable having excellent electrical characteristics and enabling the implementation of an extrafine cable structure, and to a method for readily manufacturing the same.

### BACKGROUND ART

In use of a two-core flat cable for differential transmission, the external electromagnetic waves which reach the conductor wires used to transmit a signal become a cause for noise mixing in a signal. An increase and a decrease in the magnetic lines of force which cross the conductor wires cause the generation of a force called an electromotive force. The electromotive force causes unnecessary current to flow in the conductor wire pair, causing noise to mix in a signal to be transmitted.

One method for preventing noise is to surround the conductor wires with an electric conductor for shielding, in order to prevent entry of external electromagnetic waves (refer to, for example, Patent Documents 1 and 2). That is, the electromotive force is generated and released externally of the conductor wire pair.

By contrast, a twisted pair cable employs a pair of conductor wires twisted about each other for cancellation of influences of electromagnetic waves (refer to, for example, Patent Document 3). When a conductor wire is twisted by a half turn, the influence of electromagnetic waves is reversed in direction between portions of the conductor wire before and after the half-turn twisted portion. Therefore, through twisting the conductor wires about each other, an electromotive force generated at a certain portion of the twisted pair and an electromotive force generated at a part of the twisted pair shifted slightly from the certain portion cancel each other, so that unnecessary current does not flow. Thus, noise is unlikely to be generated.

Further, the twisted pair cable yields the effect of preventing a phenomenon called “crosstalk,” in which electromagnetic waves generated from an adjacent signal line become a noise source. Crosstalk arises because, when current flows through a conductor wire, magnetic lines of force are generated around the conductor wire. However, by means of twisting the paired conductor wires about each other, the direction of generated magnetic lines of force reverses every half turn, so that the generated magnetic lines of force cancel each other. Thus, outgoing magnetic lines of force are reduced. As a result, crosstalk is unlikely to arise.

A technique of further restraining the generation of noise by means of providing a shield around the twisted pair cable is also proposed (refer to, for example, Patent Document 4).

### PRIOR ART DOCUMENT

### Patent Document

[Patent Document 1] Japanese Patent Application Laid-Open (kokai) No. 2001-195924

[Patent Document 2] Japanese Patent Application Laid-Open (kokai) No. 2008-004275

[Patent Document 3] Japanese Patent No. 3918067

[Patent Document 4] Japanese Kohyo Patent Publication No. 2003-508882

### SUMMARY OF THE INVENTION

### Problems to be Solved by the Invention

However, when a pair cable, such as a two-core flat cable or a twisted pair cable, is covered with a shield, the shield assumes an elliptical shape. The shielded pair cable has a drawback in that, as the distance between the shield and the pair cable reduces, the transmission loss for a high frequency signal increases. The transmission loss has such a characteristic as to be minimized when the shield is infinitely far from the pair cable; i.e., when the shield is not provided, and to increase as the shield is closer to the pair cable. Also, there is a problem in that, as the signal frequency increases beyond 1 MHz, the transmission loss increases, since an inductive loss is electromagnetically generated from shielding.

The pair cable is also employed in electronic endoscopes, ultrasonic imaging probes, catheter systems, etc. In such applications, there has been demand for a high frequency extrafine pair cable having excellent electrical characteristics, such as low transmission loss, and enabling the implementation of an extrafine cable structure.

Thus, an object of the present invention is to provide a high frequency extrafine pair cable having excellent electrical characteristics, such as low transmission loss, and enabling the implementation of an extrafine cable structure. Another object is to provide a method for manufacturing the same.

### Means for Solving the Problems

The present inventors have found that the above-mentioned objects are achieved by means of using a shield tube assuming the form of a hollow cylinder as a shield layer, and providing a space between the pair cable and an inner surface of the shield tube in a region other than the region where a part of the pair cable accommodated in the shield tube is in contact with the inner surface of the shield tube, or providing a low-permittivity substance having a relative dielectric constant of 3 or less between the pair cable and an inner surface of the shield tube in a region other than the region where a part of the pair cable is in contact with the inner surface of the shield tube. The present invention has been accomplished on the basis of this finding.

Accordingly, the present invention provides a high frequency extrafine pair cable, characterized in that a pair cable is accommodated in a shield tube assuming the form of a hollow cylinder, the pair cable comprising two insulation coated wires each comprising an inner conductor and an insulator layer formed on an outer circumference of the inner conductor, and a space is present between the pair cable and an inner surface of the shield tube in a region other than the region where a part of the pair cable is in contact with the inner surface of the shield tube.

The present invention also provides a high frequency extrafine pair cable, characterized in that a pair cable is accommodated in a shield tube assuming the form of a hollow cylinder, the pair cable comprising two insulation coated wires each comprising an inner conductor and an insulator layer formed on an outer circumference of the inner conductor, and a low-permittivity substance having a relative dielectric constant of 3 or less is present between the pair cable and an inner surface of the shield tube in a region other than the region where a part of the pair cable is in contact with the inner surface of the shield tube.

The present invention provides a method for manufacturing a high frequency extrafine pair cable, characterized by comprising inserting a pair cable into a shield tube assuming the form of a hollow cylinder and having such an inside diameter as to allow insertion of the pair cable, the pair cable comprising two insulation coated wires each comprising an inner conductor and an insulator layer formed on an outer circumference of the inner conductor, in such a manner as to provide a space between the pair cable and an inner surface of the shield tube in a region other than the region where a part of the pair cable is in contact with the inner surface of the shield tube.

The present invention also provides a method for manufacturing a high frequency extrafine pair cable, characterized by comprising inserting a pair cable into a shield tube assuming the form of a hollow cylinder and having such an inside diameter as to allow insertion of the pair cable, the pair cable comprising two insulation coated wires each comprising an inner conductor and an insulator layer formed on an outer circumference of the inner conductor, and drawing the shield tube by use of a die while retaining a circular sectional shape of the shield tube, so as to fix the pair cable through establishment of contact of an inner surface of the shield tube with the pair cable and in such a manner as to provide a space between the pair cable and the inner surface of the shield tube in a region other than the contact region.

### Effects of the Invention

The high frequency extrafine pair cable of the present invention can retain the shield of the pair cable in the form of a hollow cylinder; can have excellent electrical characteristics, such as low transmission loss; enables the implementation of an extrafine cable structure; and can be readily manufactured.

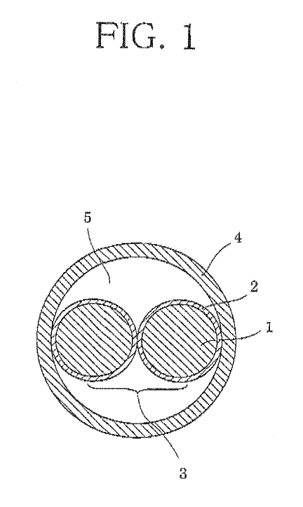

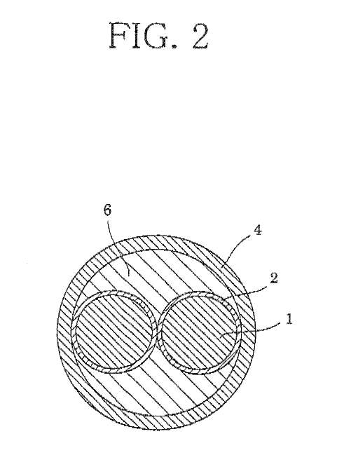

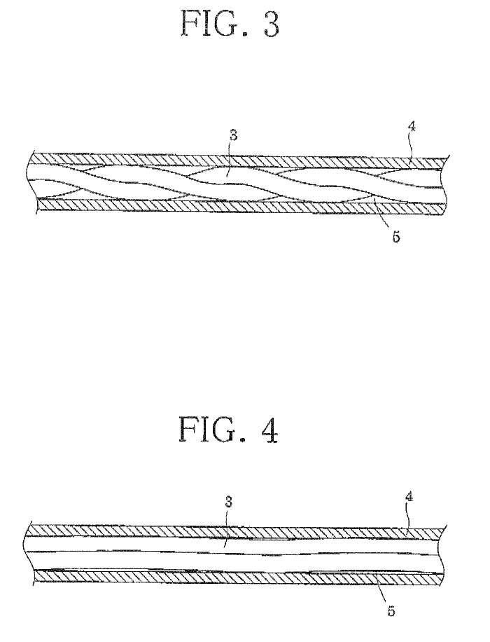

### BRIEF DESCRIPTION OF THE DRAWINGS

[FIG. 1] Sectional view showing an example of a high frequency extrafine pair cable of the present invention.

[FIG. 2] Sectional view showing another example of a high frequency extrafine pair cable of the present invention.

[FIG. 3] Schematic view of a high frequency extrafine pair cable of the present invention assuming the form of a twisted pair cable, showing a state in which only a shield tube is halved.

[FIG. 4] Schematic view of a high frequency extrafine pair cable of the present invention assuming the form of a two-core flat cable, showing a state in which only a shield tube is halved.

### BEST MODE FOR CARRYING OUT THE INVENTION

Embodiments of the present invention will next be described with reference to the drawings.

FIG. 1 is a sectional view of an embodiment of the high frequency extrafine pair cable of the present invention configured such that a pair cable 3 is accommodated in a shield tube 4 assuming the form of a hollow cylinder, the pair cable 3 comprising two insulation coated wires each comprising an inner conductor 1 and an insulator layer 2 formed on the outer circumference of the inner conductor 1, and a space 5 is present between the pair cable 3 and the inner surface of the shield tube 4 in a region other than the region where a part of the pair cable 3 is in contact with the inner surface of the shield tube 4. FIG. 2 is a sectional view of another embodiment of the high frequency extrafine pair cable of the present invention configured such that a low-permittivity substance 6 having a relative dielectric constant of 3 or less is present between the pair cable 3 and the inner surface of the shield tube 4 in a region other than the region where a part of the pair cable 3 is in contact with the inner surface of the shield tube 4.

FIG. 3 is a schematic view of a state in which only the shield tube 4 is halved, for illustrating a high frequency extrafine pair cable of the present invention configured such that the pair cable 3 assumes the form of a twisted pair cable, and the space 5 is provided between the pair cable and the inner surface of the shield tube in a region other than the region where a part of the pair cable accommodated in the shield tube is in contact with the inner surface of the shield tube. FIG. 4 is a schematic view of a state in which only the shield tube 4 is halved, for illustrating a high frequency extrafine pair cable of the present invention configured such that the pair cable 3 assumes the form of a two-core flat cable; the pair cable is merely inserted into the shield tube with the resultant shield tube not being drawn; and the space 5 is provided between the pair cable and the inner surface of the shield tube in a region other than the region where a part of the pair cable accommodated in the shield tube is in contact with the inner surface of the shield tube.

No particular limitation is imposed on the inner conductor which partially constitutes the insulation coated wire of the high frequency extrafine pair cable of the present invention, so long as the inner conductor has high electrical conductivity. Examples of the wire used as the inner conductor include a wire formed from copper, gold, silver, aluminum, chromium, or tin, or an alloy thereof; such a wire plated with copper, silver, gold, tin, chromium, or nickel; and a wire formed from an in-situ metal fiber reinforced copper alloy. Preferably, there is employed a copper wire, a silver wire, or a silver-plated copper wire, each of which has high electrical conductivity. The inner conductor may be a single wire or of a plurality of (e.g., seven or 19) strands twisted together. Each of the wires may have a circular, elliptical, or rectangular sectional shape.

The inner conductor formed from an in-situ metal fiber reinforced copper alloy is of a copper matrix reinforced with metal fiber and refers to a wire formed in such a manner that metal fiber is formed in the wire in situ; i.e., in the course of formation of the wire. An example of such wire is a wire in which the copper matrix contains fibrous silver formed in situ and having a maximum diameter of 2.5 μm or less and an average diameter of 1.0 μm or less.

The inner conductor formed from such an in-situ metal fiber reinforced copper alloy is obtained as follows: an alloy material which contains silver in an amount of 1 mass % to 25 mass % and copper substantially as balance is swaged as needed; then, the alloy material is subjected to a primary cold wire drawing process; then, the alloy material is subjected to solution treatment; subsequently, the alloy material is subjected to a secondary cold wire drawing process so as to form fibrous silver in the copper matrix in situ, thereby yielding a wire; and, by use of at least one thus-formed wire, the inner conductor is formed. The alloy material is not limited to the above-mentioned alloy. For example, there may also be employed an alloy material which contains silver in an amount of 1 mass % to 25 mass, zirconium in an amount of 0.01 mass % to 8 mass %, and the balance being substantially copper.

The insulator layer which partially constitutes the insulation coated wire of the high frequency extrafine pair cable of the present invention is obtained by means of forming a coating layer by use of a material having low permittivity; for example, a fluorine-based resin, an olefin-based resin, a polystyrene-based resin, polyester, polyurethane, ABS resin, or polyimide, or foam thereof. Also, enamel coating may serve as the insulation layer. However, in view of low permittivity, suitability for implementation of an extrafine diameter, and flex resistance, fluorine-based resins, such as PTFE (relative dielectric constant 2.1), PFA (relative dielectric constant 2.1), FEP (relative dielectric constant 2.1), and ETFE (relative dielectric constant 2.4 to 2.6); polyethylene (relative dielectric constant 2.3); polypropylene (relative dielectric constant 2.2 to 2.6); etc. are preferred.

In the high frequency extrafine pair cable of the present invention, the pair cable may be a twisted pair cable or a two-core flat cable or may be such that two insulation coated wires are present without being twisted or bonded together. However, the use of the twisted pair cable is preferred, since influences of electromagnetic waves cancel each other, and thus crosstalk is unlikely to arise. The two-core flat cable may be manufactured in such a manner that two insulation coated wires are bonded together by fusion, two insulation coated wires are fixed together by taping, or two inner conductors are disposed in parallel in such a manner as to not come into contact with each other and are then simultaneously coated with an insulator layer.

In the high frequency extrafine pair cable of the present invention, the pair cable composed of two insulation coated wires each consisting of the inner conductor and the insulator layer formed on the outer circumference of the inner conductor is accommodated in the shield tube assuming the form of a hollow cylinder. The shield tube may be a tube made of an electrically conductive metal, such as copper, gold, silver, aluminum, or an alloy thereof, or SUS, a resin tube plated with an electrically conductive metal, a resin tube wound with electrically conductive metal foil, such as copper foil, or a tube of an electrically conductive metal assuming the form of a spring or a coil.

The high frequency extrafine pair cable of the present invention may be configured such that the pair cable is fixed through contact between the pair cable and the inner surface of the shield tube, and a space is present between the pair cable and the inner surface of the shield tube in a region other than the contact region. The fixation may be as follows: the shield tube having the pair cable inserted therein is drawn by use of a die while retaining a circular sectional shape of the shield tube, so as to fix the pair cable within the shield tube through establishment of contact of the inner circumferential surface of the shield tube with the pair cable; the shield tube having the pair cable inserted therein is dented at appropriate intervals so as to fix the pair cable within the shield tube; or the pair cable having flexible projections provided at appropriate intervals is inserted into the shield tube so as to fix the pair cable within the shield tube. Also, a low-permittivity substance having a relative dielectric constant of preferably 3 or less; for example, a fluorine-based resin, such as PTFE (relative dielectric constant 2.1), PFA (relative dielectric constant 2.1), FEP (relative dielectric constant 2.1), or ETFE (relative dielectric constant 2.4 to 2.6); polyethylene (relative dielectric constant 2.3); or polypropylene (relative dielectric constant 2.2 to 2.6), may be present at least in a part of the space between the pair cable and the inner surface of the shield tube.

Also, the high frequency extrafine pair cable of the present invention may be configured such that the pair cable is merely inserted into the shield tube and is not fixed, and a space is present between the pair cable and the inner surface of the shield tube in a region other than the region where a part of the pair cable accommodated in the shield tube is in contact with the inner surface of the shield tube (the contact region varies with displacement of the high frequency extrafine pair cable of the present invention). Also, a low-permittivity substance having a relative dielectric constant of 3 or less may be present at least in a part of the space between the pair cable and the inner surface of the shield tube.

The method for manufacturing a high frequency extrafine pair cable of the present invention includes inserting the pair cable into the shield tube of the above-mentioned material assuming the form of a hollow cylinder and having such an inside diameter as to allow insertion of the pair cable; i.e. having an inside diameter greater than the diameter of the pair cable, the pair cable including two insulation coated wires each including the inner conductor of the above-mentioned material and the insulator layer of the above-mentioned material formed on the outer circumference of the inner conductor, in such a manner as to provide a space between the pair cable and the inner surface of the shield tube in a region other than the region where a part of the pair cable is in contact with the inner surface of the shield tube. In the case where a low-permittivity substance having a relative dielectric constant of preferably 3 or less is provided at least in a part of the space between the pair cable and the inner surface of the shield tube, after the layer of the low-permittivity substance is formed around the pair cable, the pair cable having the layer of the low-permittivity substance is inserted into the shield tube assuming the form of a hollow cylinder and having such an inside diameter as to allow insertion of the pair cable having the layer of the low-permittivity substance.

Also, the method for manufacturing a high frequency extrafine pair cable of the present invention includes inserting the pair cable into the shield tube of the above-mentioned material assuming the form of a hollow cylinder and having such an inside diameter as to allow insertion of the pair cable, the pair cable including two insulation coated wires each including the inner conductor of the above-mentioned material and the insulator layer of the above-mentioned material formed on the outer circumference of the inner conductor, and drawing the resultant shield tube by use of a die while retaining the circular sectional shape of the shield tube, so as to fix the pair cable through establishment of contact of the inner surface of the shield tube with the pair cable and in such a manner as to provide a space between the pair cable and the inner surface of the shield tube in a region other than the contact region. In the case where a low-permittivity substance having a relative dielectric constant of preferably 3 or less is provided at least in a part of the space between the pair cable and the inner surface of the shield tube, after the layer of the low-permittivity substance is formed around the pair cable, the pair cable having the layer of the low-permittivity substance is inserted into the shield tube assuming the form of a hollow cylinder and having such an inside diameter as to allow insertion of the pair cable having the layer of the low-permittivity substance; then, the above-mentioned subsequent operation is continued.

A method for manufacturing an insulation coated wire composed of an inner conductor and an insulator layer formed on the outer circumference of the inner conductor, a method for manufacturing a twisted pair cable or two-core flat cable composed of two insulation coated wires, and a method for drawing a shield tube assuming the form of a hollow cylinder by use of a die while retaining the circular sectional shape of the shield tube are well known. The present invention employs such well-known methods.

The shield tube employed in the method for manufacturing a high frequency extrafine pair cable of the present invention needs to have such an inside diameter as to allow easy insertion of the pair cable. However, an excessively large inside diameter is unfavorable because of too much play of the pair cable in the shield tube and excess trouble in drawing through a die. Drawing through a die is conducted to such an extent as to fix the pair cable against sliding of the pair cable within the shield tube by means of establishment of contact of the inner surface of the shield tube with the pair cable, but leave a space between the pair cable and the inner surface of the shield tube in a region other than the contact region.

The high frequency extrafine pair cable manufactured by the above-mentioned manufacturing method of the present invention may be employed in a variety of conventional applications which use an extrafine pair cable, particularly, in electronic endoscopes, ultrasonic imaging probes, catheter systems, etc.

For example, in an electronic endoscope, its distal end portion is provided with a timing generator for generating a drive signal for driving a CCD, and a driver for generating a CCD drive signal through voltage conversion or the like of the drive signal and applying the CCD drive signal to the CCD, and its insert portion is provided with a differential driver disposed at least on a side toward the proximal end of the insert portion. A reference clock output from a reference signal generation circuit provided within a video processor is input to the differential driver. One end of an extrafine pair cable is connected to an output terminal of the differential driver. The extrafine pair cable extends from a connector which serves as one end of a signal transmission path of the electronic endoscope to the distal end portion which serves as the other end of the signal transmission path, through a universal cable portion, an operation portion, and the insert portion. The extrafine pair cable enables the reference clock to be transmitted in the form of a differential signal; i.e., in the form of a differential reference clock, from the proximal end of the signal transmission path to the other end of the signal transmission path; i.e., to the distal end portion. The thus-transmitted differential reference clock is input to a differential receiver provided within the distal end portion. The reference clock output from the output terminal of the differential receiver is input to the timing generator.

Thus, preferably, the high frequency extrafine pair cable of the present invention is thin; i.e., the outside diameter of the shield tube is 500 μm or less.

When the high frequency extrafine pair cable of the present invention is employed in ordinary applications, not in those applications which use an extrafine pair cable, such as electronic endoscopes, ultrasonic imaging probes, and catheter systems, a protective coating layer (sheath) may be formed on the exterior of the shield tube. Examples of the material of the protective coating layer include fluorine-based resins, olefin-based resins, polyester, polyurethane, ABS resin, polyimide, polyamide, vinyl chloride resin, and silicone resin.

### Examples 1 to 11

Insulation coated wires having outside diameters shown in Table 1 were obtained by forming insulator layers formed of materials shown in Table 1 and having permittivities shown in Table 1 on the outer circumferences of copper wires serving as inner conductors and having outside diameters shown in Table 1. Examples 1 to 9 employed a twisted pair cable formed of the two insulation coated wires. Examples 10 and 11 employed a two-core flat cable formed of the two insulation coated wires. The twisted pair cable or the two-core flat cable was inserted into a raw shield tube of copper assuming the form of a hollow cylinder and having inside and outside diameters shown in Table 1. Examples 1 to 5 and 11 employed, as the high frequency extrafine pair cable of the present invention, a raw shield tube of copper had a twisted pair cable or two-core flat cable inserted therein. In Examples 6 to 10, a raw shield tube of copper having a twisted pair cable or two-core flat cable inserted therein was drawn through a die while retaining the circular sectional shape of the shield tube, so as to fix the twisted pair cable or the two-core flat cable against sliding of the twisted pair cable or the two-core flat cable within the shield tube by means of establishment of contact of the inner surface of the shield tube with the twisted pair cable or the two-core flat cable and in such a manner as to provide a space between the twisted pair cable or the two-core flat cable and the inner surface of the shield tube in a region other than the contact region. The shield tube of copper resulting from drawing through a die (shield tube in product) had outside and inside diameters as shown in Table 1. The thus-obtained high frequency extrafine pair cables exhibited characteristic impedances and transmission losses (at 40 MHz and 100 MHz) shown in Table 1.

TABLE 1

| | | | | | | | | | | Example | Example |
|---|---|---|---|---|---|---|---|---|---|---|---|
| | Example 1 | Example 2 | Example 3 | Example 4 | Example 5 | Example 6 | Example 7 | Example 8 | Example 9 | 10 | 11 |
| Outside diameter | 80 | 74 | 74 | 78 | 75 | 78 | 68 | 71 | 74 | 74 | 74 |
| of | | | | | | | | | | | |
| inner conductor | | | | | | | | | | | |
| (μm) | | | | | | | | | | | |
| Material of | PFA | PFA | ETFE | ETFE | Urethane | ETFE | ETFE | ETFE | PFA | PFA | PFA |
| insulator layer | | | | | | | | | | | |
| Relative dielectric | 2.1 | 2.1 | 2.4 | 2.4 | Approx. 5 | 2.4 | 2.4 | 2.4 | 2.1 | 2.1 | 2.1 |
| constant of | | | | | | | | | | | |
| insulator layer | | | | | | | | | | | |
| Outside diameter | 140 | 100 | 105 | 109 | 96 | 109 | 100 | 100 | 100 | 105 | 105 |
| of | | | | | | | | | | | |
| insulation coated | | | | | | | | | | | |
| wire (μm) | | | | | | | | | | | |
| Inside diameter of | 300 | 233 | 233 | 233 | 233 | 233 | 233 | 233 | 233 | 233 | 233 |
| raw shield tube | | | | | | | | | | | |
| (μm) | | | | | | | | | | | |
| Outside diameter | 450 | 288 | 288 | 288 | 288 | 288 | 288 | 288 | 288 | 288 | 288 |
| of | | | | | | | | | | | |
| raw shield tube | | | | | | | | | | | |
| (μm) | | | | | | | | | | | |
| Inside diameter of | 300 | 233 | 233 | 233 | 233 | 215 | 215 | 215 | 215 | 215 | 233 |
| shield tube in | | | | | | | | | | | |
| product (μm) | | | | | | | | | | | |
| Outside diameter | 450 | 288 | 288 | 288 | 288 | 268 | 268 | 268 | 268 | 268 | 288 |
| of | | | | | | | | | | | |
| shield tube in | | | | | | | | | | | |
| product (μm) | | | | | | | | | | | |
| Combined | 1.38 | 1.22 | 1.36 | 1.38 | 1.69 | 1.48 | 1.41 | 1.38 | 1.26 | 1.32 | 1.26 |
| relative | | | | | | | | | | | |
| dielectric constant | | | | | | | | | | | |
| of shield tube and | | | | | | | | | | | |
| two insulation | | | | | | | | | | | |
| coated wires | | | | | | | | | | | |
| Characteristic | 85 | 69 | 70 | 63 | 56 | 50 | 66 | 62 | 59 | 60 | 66 |
| impedance, | | | | | | | | | | | |
| measurement (Ω) | | | | | | | | | | | |
| Transmission loss | 0.98 | 1.45 | 1.50 | 1.68 | 2.12 | 2.33 | 2.09 | 2.01 | 1.83 | 2.04 | 1.74 |
| dB (40 MHz) | | | | | | | | | | | |
| Transmission loss | 1.56 | 2.38 | 2.46 | 2.74 | 3.52 | 4.12 | 3.11 | 3.10 | 2.72 | 2.95 | 2.65 |
| dB (100 MHz) | | | | | | | | | | | |

### DESCRIPTION OF REFERENCE NUMERALS

1: inner conductor
2: insulator layer
3: pair cable
4: shield tube
5: space
6: low-permittivity substance

1. A high frequency extrafine pair cable, characterized in that a pair cable (3) is accommodated in a shield tube (4) assuming the form of a hollow cylinder, the pair cable (3) comprising two insulation coated wires each comprising an inner conductor (1) and an insulator layer (2) formed on an outer circumference of the inner conductor (1), and a space (5) is present between the pair cable (3) and an inner surface of the shield tube (4) in a region other than the region where a part of the pair cable (3) is in contact with the inner surface of the shield tube (4).

2. A high frequency extrafine pair cable, characterized in that a pair cable (3) is accommodated in a shield tube (4) assuming the form of a hollow cylinder, the pair cable (3) comprising two insulation coated wires each comprising an inner conductor (1) and an insulator layer (2) formed on an outer circumference of the inner conductor (1), and a low-permittivity substance (6) having a relative dielectric constant of 3 or less is present between the pair cable (3) and an inner surface of the shield tube (4) in a region other than the region where a part of the pair cable (3) is in contact with the inner surface of the shield tube (4).

3. A high frequency extrafine pair cable according to claim 1, wherein the shield tube is a tube made of metal.

4. A high frequency extrafine pair cable according to claim 2, wherein the shield tube is a tube made of metal.

5. A high frequency extrafine pair cable according to claim 1, wherein the shield tube has an outside diameter of 500 μm or less.

6. A high frequency extrafine pair cable according to claim 2, wherein the shield tube has an outside diameter of 500 μm or less.

7. A high frequency extrafine pair cable according to claim 3, wherein the shield tube has an outside diameter of 500 μm or less.

8. A high frequency extrafine pair cable according to claim 4, wherein the shield tube has an outside diameter of 500 μm or less.

9. A high frequency extrafine pair cable according to claim 1, wherein the pair cable (3) is fixed through contact between a part of the pair cable (3) and the inner surface of the shield tube (4).

10. A high frequency extrafine pair cable according to claim 6, wherein the pair cable (3) is fixed through contact between a part of the pair cable (3) and the inner surface of

11. A high frequency extrafine pair cable according to claim 2, wherein the pair cable (3) is fixed through contact between a part of the pair cable (3) and the inner surface of the shield tube (4).

12. A high frequency extrafine pair cable according to claim 8, wherein the pair cable (3) is fixed through contact between a part of the pair cable (3) and the inner surface of the shield tube (4).

13. A method for manufacturing a high frequency extrafine pair cable as recited in claim 1, characterized by comprising inserting a pair cable (3) into a shield tube (4) assuming the form of a hollow cylinder and having such an inside diameter as to allow insertion of the pair cable (3), the pair cable (3) comprising two insulation coated wires each comprising an inner conductor (1) and an insulator layer (2) formed on an outer circumference of the inner conductor (1), in such a manner as to provide a space (5) between the pair cable (3) and an inner surface of the shield tube (4) in a region other than the region where a part of the pair cable (3) is in contact with the inner surface of the shield tube (4).

14. A method for manufacturing a high frequency extrafine pair cable as recited in claim 3, characterized by comprising inserting a pair cable (3) into a shield tube (4) assuming the form of a hollow cylinder and having such an inside diameter as to allow insertion of the pair cable (3), the pair cable (3) comprising two insulation coated wires each comprising an inner conductor (1) and an insulator layer (2) formed on an outer circumference of the inner conductor (1), in such a manner as to provide a space (5) between the pair cable (3) and an inner surface of the shield tube (4) in a region other than the region where a part of the pair cable (3) is in contact with the inner surface of the shield tube (4).

15. A method for manufacturing a high frequency extrafine pair cable as recited in claim 5, characterized by comprising inserting a pair cable (3) into a shield tube (4) assuming the form of a hollow cylinder and having such an inside diameter as to allow insertion of the pair cable (3), the pair cable (3) comprising two insulation coated wires each comprising an inner conductor (1) and an insulator layer (2) formed on an outer circumference of the inner conductor (1), in such a manner as to provide a space (5) between the pair cable (3) and an inner surface of the shield tube (4) in a region other than the region where a part of the pair cable (3) is in contact with the inner surface of the shield tube (4).

16. A method for manufacturing a high frequency extrafine pair cable as recited in claim 10, characterized by comprising inserting a pair cable (3) into a shield tube (4) assuming the form of a hollow cylinder and having such an inside diameter as to allow insertion of the pair cable (3), the pair cable (3) comprising two insulation coated wires each comprising an inner conductor (1) and an insulator layer (2) formed on an outer circumference of the inner conductor (1), in such a manner as to provide a space (5) between the pair cable (3) and an inner surface of the shield tube (4) in a region other than the region where a part of the pair cable (3) is in contact with the inner surface of the shield tube (4).

17. A method for manufacturing a high frequency extrafine pair cable as recited in claim 2, characterized by comprising inserting a pair cable (3) into a shield tube (4) assuming the form of a hollow cylinder and having such an inside diameter as to allow insertion of the pair cable (3), the pair cable (3) comprising two insulation coated wires each comprising an inner conductor (1) and an insulator layer (2) formed on an outer circumference of the inner conductor (1), and drawing the shield tube (4) by use of a die while retaining a circular sectional shape of the shield tube (4), so as to fix the pair cable (3) through establishment of contact of an inner surface of the shield tube (4) with the pair cable (3) and in such a manner as to provide a space (5) between the pair cable (3) and the inner surface of the shield tube (4) in a region other than the contact region.

18. A method for manufacturing a high frequency extrafine pair cable as recited in claim 4, characterized by comprising inserting a pair cable (3) into a shield tube (4) assuming the form of a hollow cylinder and having such an inside diameter as to allow insertion of the pair cable (3), the pair cable (3) comprising two insulation coated wires each comprising an inner conductor (1) and an insulator layer (2) formed on an outer circumference of the inner conductor (1), and drawing the shield tube (4) by use of a die while retaining a circular sectional shape of the shield tube (4), so as to fix the pair cable (3) through establishment of contact of an inner surface of the shield tube (4) with the pair cable (3) and in such a manner as to provide a space (5) between the pair cable (3) and the inner surface of the shield tube (4) in a region other than the contact region.

19. A method for manufacturing a high frequency extrafine pair cable as recited in claim 7, characterized by comprising inserting a pair cable (3) into a shield tube (4) assuming the form of a hollow cylinder and having such an inside diameter as to allow insertion of the pair cable (3), the pair cable (3) comprising two insulation coated wires each comprising an inner conductor (1) and an insulator layer (2) formed on an outer circumference of the inner conductor (1), and drawing the shield tube (4) by use of a die while retaining a circular sectional shape of the shield tube (4), so as to fix the pair cable (3) through establishment of contact of an inner surface of the shield tube (4) with the pair cable (3) and in such a manner as to provide a space (5) between the pair cable (3) and the inner surface of the shield tube (4) in a region other than the contact region.

20. A method for manufacturing a high frequency extrafine pair cable as recited in claim 12, characterized by comprising inserting a pair cable (3) into a shield tube (4) assuming the form of a hollow cylinder and having such an inside diameter as to allow insertion of the pair cable (3), the pair cable (3) comprising two insulation coated wires each comprising an inner conductor (1) and an insulator layer (2) formed on an outer circumference of the inner conductor (1), and drawing the shield tube (4) by use of a die while retaining a circular sectional shape of the shield tube (4), so as to fix the pair cable (3) through establishment of contact of an inner surface of the shield tube (4) with the pair cable (3) and in such a manner as to provide a space (5) between the pair cable (3) and the inner surface of the shield tube (4) in a region other than the contact region.
